(19) United States
(12) Patent Application Publication
(10) Pub. No.: US 2026/0235187 A1
(43) Pub. Date: Aug. 13, 2026

(54) Universal simulation method and system for hysteretic behavior of asynchronized double-stage energy dissipation and vibration reduction devices

(71) Applicant: Beijing University of Civil Engineering and Architecture, Beijing (CN)

(72) Inventors: Linlin XIE, Beijing (CN); Cantian YANG, Beijing (CN); Bingyan LIU, Beijing (CN); Haoxiang WANG, Beijing (CN); Hang SUN, Beijing (CN); Qianxin WEN, Beijing (CN)

(73) Assignee: Beijing University of Civil Engineering and Architecture, Beijing, BJ (CN)

(21) Appl. No.: 19/452,281

(22) Filed: Jan. 17, 2026

(30) Foreign Application Priority Data
Jul. 18, 2024 (CN) 202410967903.0

(51) Int. Cl. F16F 15/00

(52) U.S. Cl. CPC F16F 15/002; F16F 2228/06; F16F 2230/00

(57) ABSTRACT

The present disclosure provides a universal simulation method and system for hysteretic behavior of an asynchronized double-stage energy dissipation and vibration reduction device. It proposes a restoring force model for asynchronous starting double-stage energy dissipation and vibration reduction device, which can effectively conduct seismic response analysis of structures with a parallel-connected double-stage energy dissipation and vibration reduction device. Two theoretical calculation methods for performance parameters of asynchronous starting double-stage energy dissipation and vibration reduction devices are proposed. The embodiments of the present disclosure can predict the magnitude of the damping force based on the damper structure, effectively simulate the working process of asynchronous starting double-stage energy dissipation and vibration reduction devices and the damping force-displacement hysteretic curves under different positional variations, and optimize the damping force calculation method for asynchronous starting double-stage energy dissipation and vibration reduction devices.

### CROSS-REFERENCE TO RELATED APPLICATION

This application claims priority to Chinese Patent Application No. 202410967903.0, filed on Jul. 18, 2024, titled “Universal simulation method and system for hysteretic behavior of asynchronized double-stage energy dissipation and vibration reduction devices” before the China National Intellectual Property Administration, the disclosure of which is incorporated herein by reference in entirety.

### TECHNICAL FIELD

The present disclosure relates to the field of structural engineering technology, and in particular to a universal simulation method and system for hysteretic behavior of an asynchronized double-stage energy dissipation and vibration reduction devices.

### BACKGROUND

Earthquakes, as highly destructive and unpredictable natural disasters, pose a significant threat to human life and property. Energy dissipation and damping (vibration reduction) technology, with its superior energy dissipation effect and widespread application in practical engineering, has become an important means of modern earthquake resistance. Energy dissipation and damping technology involves installing energy-dissipating (damping) devices in certain parts of the structure (such as supports, shear walls, joints, or connecting components). Before the main structure enters an inelastic state, the device enters an energy-dissipating working state, dissipating energy or absorbing the energy input from the earthquake by generating frictional, bending (or shear, torsion) elasto-plastic (or viscoelastic) hysteretic deformation, thereby reducing the seismic response of the main structure.

Traditional damping devices typically include buckling-restrained braces, buckling-restrained steel plate walls, friction dampers, metal dampers, etc., they can provide lateral stiffness to the structure while adding a certain amount of damping. However, traditional damping devices cannot meet higher requirements. To address this, asynchronous starting double-stage energy dissipation damping devices are proposed, including metallic yielding asynchronized double-stage dampers and friction-metal composite asynchronized double-stage dampers.

The asynchronous-starting double-stage energy dissipation and damping device consists of two dampers and an asynchronous activation system. In the first stage, only the first-stage damper works, similar to traditional damping devices. When the deformation displacement reaches the second-stage activation displacement, the second-stage damper begins to bear force and play a role in energy dissipation and damping. At this time, the stiffness and load-carrying capacity of the asynchronous-starting double-stage energy dissipation and damping device are jointly provided by the two dampers.

The macroscopic numerical model of the damper works as a foundation for conducting seismic response analysis of structural systems. There are still unresolved issues regarding the aforementioned asynchronous-starting, double-stage energy dissipation and damping device:
(1) The lack of a restoring force model makes it difficult to conduct structural seismic response analysis;
(2) The lack of theoretical calculation methods for performance parameters makes it difficult to carry out in-depth design for actual production.

### SUMMARY

To address the aforementioned problems, the embodiments of the present disclosure provides a universal simulation method for hysteretic behavior of an asynchronized double-stage energy dissipation and vibration reduction device, applied to a metallic yielding asynchronized double-stage damper, wherein the metallic yielding asynchronized double-stage damper comprises a first sub-damper and a second sub-damper, and the method comprises:
obtaining parameters of the metallic yielding asynchronized double-stage damper,
wherein, in a case where 0<ε<Δₐ₂, a damping force of the metallic yielding asynchronized double-stage damper satisfies the following formula:

$$ε = \frac{σ}{{E}_{1}} ( 1 + {α}_{1} {\vert \frac{σ}{{F}_{y 1}} \vert}^{{η}_{1} - 1} )$$

where, ε, σ represent displacement and force of the metallic yielding asynchronized double-stage damper; E₁ represents initial stiffness of the first sub-damper; F_{y1} represents yield force of the first sub-damper; α₁, η₁ represent shape parameters of the first sub-damper; Δₐ₂ represents second-stage starting displacement.
in a case where Δₐ₂<ε<Δᵤ, a force acting solely on the first sub-damper satisfies the following formula:

$${ε}_{1} = \frac{{σ}_{1}}{{E}_{1}} ( 1 + {α}_{1} {\vert \frac{{σ}_{1}}{{F}_{y 1}} \vert}^{{η}_{1} - 1} )$$

and a force solely acting on the second sub-damper satisfies the following formula:

$${ε}_{2} = \frac{{σ}_{2}}{{E}_{2}} ( 1 + {α}_{2} {\vert \frac{{σ}_{2}}{{F}_{y 2}} \vert}^{{η}_{2} - 1} ) + {Δ}_{a 2}$$

the damping force of the metallic yielding asynchronized double-stage damper is:

$$σ = {σ}_{1} + {σ}_{2} ;$$

where, E₂ represents initial stiffness of the second sub-damper; F_{y2} represents yield force of the second sub-damper; Au represents maximum axial deformation; α₂, η₂ represents shape parameters of the second sub-damper; σ₁ represents a force of the first sub-damper; σ₂ represents a force of the second sub-damper.

According to some embodiments of the present disclosure, when ε varies from Δᵤ to Δ_{E}, the damping force of the metallic yielding asynchronized double-stage damper satisfies the following formula:
the force acting solely on the first sub-damper is:

$${ε}_{1}^{′} = \frac{{σ}_{1}^{′} - {σ}_{B}}{{E}_{1}} ( 1 + {α}_{1} {\vert \frac{{σ}_{1}^{′} - {σ}_{B}}{2 {F}_{y 1}} \vert}^{{η}_{1} - 1} ) + {Δ}_{u}$$

the force acting solely on the second sub-damper is:

$${ε}_{2}^{′} = \frac{{σ}_{2}^{′} - ( {σ}_{u} - {σ}_{B} )}{{E}_{2}} ( 1 + {α}_{2} {\vert \frac{{σ}_{2}^{′} - ( {σ}_{u} - {σ}_{B} )}{2 {F}_{y 2}} \vert}^{{η}_{2} - 1} ) + {Δ}_{u}$$

the damping force of the metallic yielding asynchronized double-stage damper is:

$$σ = {σ}_{1}^{′} + {σ}_{2}^{′} ;$$

where, E₂ represents initial stiffness of the second sub-damper; σᵤ, Δᵤ represent force and displacement at an inflection point; σ_{B} represents a force at point B; F_{y2} represents yield force of the second sub-damper; Δ_{E} represents the inflection point, at which the second sub-damper stops working; σ₁′ represents the force of the first sub-damper; σ₂′ represents the force of the second sub-damper.
when ε varies from Δ_{E} to Δ_{F}, the damping force of the metallic yielding asynchronized double-stage damper is σ=σ₁′, where Δ_{F} is an unloading completion point.

According to some embodiments of the present disclosure, the method further comprises:
plotting a skeleton curve and an unloading curve based on the calculation formula of the damping force of the metallic yielding asynchronized double-stage damper.

According to some embodiments of the present disclosure, the method further comprises:
designing performance parameters of the metallic yielding asynchronized double-stage damper based on the calculation formula of the damping force and a vibration reduction requirement of the metallic yielding asynchronized double-stage damper.

According to another aspect of the present disclosure, there is provided a universal simulation method for hysteretic behavior of an asynchronized double-stage energy dissipation and vibration reduction device, applied to a friction-metal composite asynchronized double-stage damper, wherein the friction-metal composite asynchronized double-stage damper comprises a first friction sub-damper and a second metal sub-damper, and the method comprises:
obtaining parameters of the friction-metal composite asynchronized double-stage damper;
wherein, in a case where 0<ε<Δₐ₁, a damping force of the friction-metal composite asynchronized double-stage damper satisfies the following formula:

$$σ = {E}_{1} \cdot ε$$

where, ε, σ represent displacement and force of the friction-metal composite asynchronized double-stage damper; E₁ represents initial stiffness of the first friction sub-damper; Δₐ₁ represents a displacement when a load increases to a yield force of the first friction sub-damper.

in a case where Δₐ₁<ε<Δₐ₂, the damping force of the friction-metal composite asynchronized double-stage damper satisfies the following formula:

$$σ = {F}_{y 1}$$

where F_{y1} represents the yield force of the first friction sub-damper; Δₐ₂ represents second-stage starting displacement.
in a case where Δₐ₂<ε<Δᵤ,
a force acting solely on the first friction sub-damper is: σ₁=F_{y1};
a force acting solely on the second metal sub-damper is:

$${ε}_{2} = \frac{{σ}_{2}}{{E}_{2}} ( 1 + {α}_{2} {\vert \frac{{σ}_{2}}{{F}_{y 2}} \vert}^{{η}_{2} - 1} ) + {Δ}_{a 2}$$

where, E₂ represents initial stiffness of the second metal sub-damper; F_{y2} represents yield force of the second metal sub-damper; Δₐ₂ represents second-stage starting displacement; Δᵤ represents maximum axial deformation; α₂, η₂ represents shape parameters of the second metal sub-damper;
the damping force of the friction-metal composite asynchronized double-stage damper is: σ=σ₁+σ₂.

According to some embodiments of the present disclosure, when ε varies from Δᵤ to Δ_{E}, the damping force of the friction-metal composite asynchronized double-stage damper satisfies the following formula:
the force acting solely on the first friction sub-damper is:

$${σ}_{1}^{′} = {F}_{y 1} + {E}_{1} \cdot ( ε - {Δ}_{u} ) At that time {σ}_{1}^{′} \leq - {F}_{y 1} , {σ}_{1}^{′} = - {F}_{y 1} ,$$

the force acting solely on the second metal sub-damper is:

$${ε}_{2}^{′} = \frac{{σ}_{2}^{′} - ( {σ}_{u} - {σ}_{B} )}{{E}_{2}} ( 1 + {α}_{2} {\vert \frac{{σ}_{2}^{′} - ( {σ}_{u} - {σ}_{B} )}{2 {F}_{y 2}} \vert}^{{η}_{2} - 1} ) + {Δ}_{u}$$

where, E₂ represents initial stiffness of the second metal sub-damper; σᵤ, Δᵤ represent force and displacement at an inflection point; σ_{B} represents a force at point B; F_{y2} represents yield force of the second metal sub-damper; Δ_{E} represents the inflection point, at which the second metal sub-damper stops working; σ₁′ represents the force of the first friction sub-damper; σ₂′ represents the force of the second metal sub-damper.
the damping force of the friction-metal composite asynchronized double-stage damper is: σ=σ₁′+σ₂′;
when ε varies from Δ_{E} to Δ_{F}, the damping force of the friction-metal composite asynchronized double-stage damper is σ=σ₁′, where Δ_{F} is an unloading completion point.

According to some embodiments of the present disclosure, the method further comprises:
plotting a skeleton curve and an unloading curve based on the calculation formula of the damping force of the friction-metal composite asynchronized double-stage damper.

According to some embodiments of the present disclosure, the method further comprises:
designing performance parameters of the friction-metal composite asynchronized double-stage damper based on the calculation formula of the damping force and a vibration reduction requirement of the friction-metal composite asynchronized double-stage damper.

Embodiments of the present disclosure further provide a universal simulation system for hysteretic behavior of an asynchronized double-stage energy dissipation and vibration reduction device, applied to a metallic yielding asynchronized double-stage damper, wherein the metallic yielding asynchronized double-stage damper comprises a first sub-damper and a second sub-damper, and the system is used to perform the method as described above.

Embodiments of the present disclosure further provide a universal simulation system for hysteretic behavior of an asynchronized double-stage energy dissipation and vibration reduction device, applied to a friction-metal composite asynchronized double-stage damper, wherein the friction-metal composite asynchronized double-stage damper comprises a first friction sub-damper and a second metal sub-damper, and the system is used to perform the method as described above.

The embodiments of the present disclosure provides a universal simulation method and system for hysteretic behavior of an asynchronized double-stage energy dissipation and vibration reduction devices, it proposes a restoring force model for asynchronous starting double-stage energy dissipation and vibration reduction device, which can effectively carry out seismic response analysis of structures with a parallel-connected double-stage energy dissipation and vibration reduction device. Two theoretical calculation methods for performance parameters of asynchronous starting double-stage energy dissipation and vibration reduction devices are proposed, which is beneficial for the in-depth design of production-oriented asynchronous starting double-stage energy dissipation and vibration reduction devices.

The present disclosure provides a universal simulation method and system for hysteretic behavior of an asynchronized double-stage energy dissipation and vibration reduction device. It proposes a restoring force model for asynchronous starting double-stage energy dissipation and vibration reduction device, which can effectively conduct seismic response analysis of structures with a parallel-connected double-stage energy dissipation and vibration reduction device. Two theoretical calculation methods for performance parameters of asynchronous starting double-stage energy dissipation and vibration reduction devices are proposed . . .

### BRIEF DESCRIPTION OF THE DRAWINGS

To more clearly illustrate the technical solutions in the embodiments of the present disclosure or the prior art, the drawings used in the description of the embodiments or the prior art will be briefly introduced below. Obviously, the drawings described below are only part of embodiments of the present disclosure. For those skilled in the art, other drawings can be obtained based on the provided drawings without creative effort.

FIG. 1 shows a skeleton curve of the metallic yielding asynchronized double-stage damper provided in an embodiment of the present disclosure;

FIG. 2 shows a hysteretic curve of the metallic yielding asynchronized double-stage damper provided in an embodiment of the present disclosure;

FIG. 3 is a flowchart of algorithm for the metallic yielding asynchronized double-stage damper provided in an embodiment of the present disclosure;

FIG. 4 shows load-deformation curves of PDYBRB1 and PDYBRB2 compared by experiment and theoretical calculation in an embodiment of the present disclosure;

FIG. 5 shows load-deformation curves of PDCSD1 and PDCSD2 compared by experiment and theoretical calculation in an embodiment of the present disclosure;

FIG. 6 shows load-deformation curves of PDSPD1 and PDSPD2 compared by experiment and theoretical calculation in an embodiment of the present disclosure;

FIG. 7 shows a skeleton curve of the friction-metal composite asynchronized double-stage damper provided in an embodiment of the present disclosure;

FIG. 8 shows a hysteretic curve of the friction-metal composite asynchronized double-stage damper provided in an embodiment of the present disclosure;

FIG. 9 is a flowchart of algorithm for the friction-metal composite asynchronized double-stage damper provided in an embodiment of the present disclosure;

FIG. 10 shows the experimental and theoretical calculation load-deformation curves of APDFMD1, APDFMD2 and APDFMD3 provided in an embodiment of the present disclosure.

### DETAILED DESCRIPTION OF EMBODIMENTS

To make the above-mentioned objects, features, and advantages of the present disclosure more apparent and understandable, specific embodiments of the present disclosure will be described in detail below with reference to the accompanying drawings. It should be understood that the specific embodiments described herein are merely illustrative of the present disclosure and are not intended to limit the present disclosure.

In a metallic yielding asynchronized double-stage damper, the two core plates do not always work together/at the same time. After deformation reaches a preset displacement, some core plates activate asynchronously, resulting in a double-stage force characteristic of the support component. In the initial stage, only the first core plate is stressed, similar to a traditional metallic yielding damper, when the first core plate deforms to a specified deformation, the force-transmitting bolt contacts the wall of the elongated hole, causing the second core plate to cooperate in bearing the force and play a role in energy dissipation and vibration reduction. At this point, the stiffness and bearing capacity come from the sum of the two core plates, and the entire force-bearing process exhibits force characteristics with two different stages.

For a friction-metal composite asynchronized double-stage damper, in the first working stage, only the friction unit operates independently, similar to a traditional friction damper, at this stage, the force-transmitting bolt slides freely in the elongated hole, and the asynchronous starting metal unit is in an unloaded state. In the second working stage, after the deformation reaches the preset displacement, the asynchronous starting metal unit is activated. The force-transmitting bolt contacts the wall of the elongated hole, causing the steel seam plate to deform. At this point, the asynchronous starting metal unit begins to be loaded, and its stiffness and strength come from the sum of the two units. The entire force-bearing process exhibits force characteristics with two distinct stages.

The present disclosure aims to solve two problems in the prior art: the lack of a restoring force model for asynchronous starting double-stage energy dissipation and vibration reduction devices (metallic yielding type asynchronized double-stage dampers and friction-metal combination type asynchronized double-stage dampers), making it difficult to carry out structural seismic response analysis, and the lack of theoretical calculation methods for production design.

Firstly, regarding the first problem (the calculation formula for asynchronous starting double-stage energy dissipation and vibration reduction devices is unclear, making it impossible to accurately obtain the calculated stress based on the device's structure), the present disclosure proposes a method for predicting the hysteretic behavior of asynchronous starting double-stage energy dissipation and vibration reduction devices, establishing a restoring force model for these asynchronous starting double-stage energy dissipation and vibration reduction devices. This solves the problem of studying the mechanical properties of asynchronous starting double-stage energy dissipation and vibration reduction devices and can effectively predict the stress magnitude of the asynchronous starting double-stage energy dissipation and vibration reduction devices. It is applicable to various energy dissipation and vibration reduction structural systems.

Secondly, regarding the second problem, the embodiments of present disclosure propose two theoretical calculation methods for the performance parameters of asynchronous starting double-stage energy dissipation and vibration reduction devices. These methods can be used to further design the asynchronous starting double-stage energy dissipation and vibration reduction devices according to the performance parameters required by the building structure, so as to meet the energy dissipation and vibration reduction performance requirements of the building structure at different stress stages.

The embodiments of the present disclosure utilize the structural features of two asynchronous starting double-stage energy dissipation and vibration reduction devices to calculate the stress of the vibration reduction device under different working conditions.

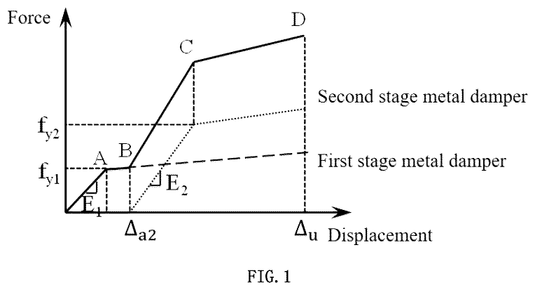

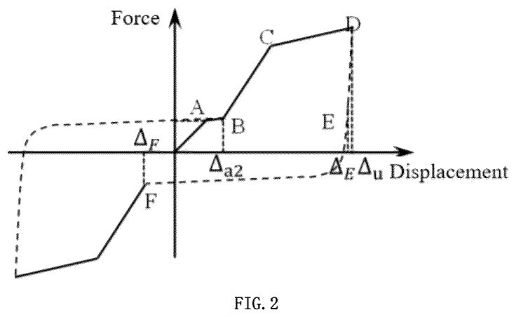

As a feasible implementation method, the embodiment of the present disclosure provides a theoretical calculation method for the performance parameters of a metallic yielding asynchronized double-stage damper. It predicts stress in the four operating stages of the existing metallic yielding asynchronized double-stage damper and provides a stress prediction formula based on the device structure. This solves the problem of studying the mechanical performance of this metallic yielding asynchronized double-stage damper and can effectively predict the restoring force model of the metallic yielding asynchronized double-stage damper. FIG. 1 shows the skeleton curve of the metallic yielding asynchronized double-stage damper provided in the embodiment of the present disclosure, and FIG. 2 shows the hysteretic curve of the metallic yielding asynchronized double-stage damper provided in the embodiment of the present disclosure.

### Skeleton Curve:

(1) When 0<ε<Δₐ₂, this indicates that only the first sub-damper of the metallic yielding asynchronized double-stage damper is involved in the operation. When the load increases to the yield force of the first sub-damper, it reaches point A in the skeleton curve. At this time, only the first sub-damper provides stiffness and bearing capacity, the asynchronous force transmission system is not activated, and the deformation of the second sub-damper is 0. When the axial deformation reaches point B in the skeleton curve, the deformation of the second core plate is still 0, but it is about to start.

At this time, the damping force of the metallic yielding asynchronized double-stage damper is:

$$ε = \frac{σ}{{E}_{1}} ( 1 + {α}_{1} {\vert \frac{σ}{{F}_{y 1}} \vert}^{{η}_{1} - 1} )$$

wherein, ε, σ represent the displacement and force of the metallic yielding asynchronized double-stage damper; E₁ represents the initial stiffness of the first sub-damper; F_{y1} represents the yield force of the first sub-damper; and α₁, η₁ represents the shape parameters of the first sub-damper.

(2) When Δₐ₂<ε<Δᵤ, this indicates that the second sub-damper of the metallic yielding asynchronized double-stage damper is activated. The two sub-dampers work in parallel. The first sub-damper continues to consume energy, while the second sub-damper provides stiffness and bearing capacity. When the second sub-damper yields, the stress on the support reaches point C in the skeleton curve until the support reaches its maximum axial deformation Δᵤ.

At this moment, the force acting solely on the first sub-damper is:

$${ε}_{1} = \frac{{σ}_{1}}{{E}_{1}} ( 1 + {α}_{1} {\vert \frac{{σ}_{1}}{{F}_{y 1}} \vert}^{{η}_{1} - 1} )$$

The force acting solely on the second sub-damper is:

$${ε}_{2} = \frac{{σ}_{2}}{{E}_{2}} ( 1 + {α}_{2} {\vert \frac{{σ}_{2}}{{F}_{y 2}} \vert}^{{η}_{2} - 1} ) + {Δ}_{a 2}$$

where E₂ is the initial stiffness of the second sub-damper; F_{y2} is the yield force of the second sub-damper; Δₐ₂ is the displacement at point B, i.e., the second-stage starting displacement; α₂, η₂ are the shape parameters of the second sub-damper.

Then the damping force of the metallic yielding asynchronized double-stage damper at this time is: σ=σ₁+σ₂.

### Unloading Curve:

Under repeated loading, when the steel yields in one direction and is unloaded to zero and then loaded in the opposite direction, that is, when ε varies from Δᵤ to Δ_{E}, the first and second sub-dampers work together and unload together, the second sub-damper stops working when the inflection point E is reached.

At this moment, the force acting solely on the first sub-damper is:

$${ε}_{1}^{′} = \frac{{σ}_{1}^{′} - {σ}_{B}}{{E}_{1}} ( 1 + {α}_{1} {\vert \frac{{σ}_{1}^{′} - {σ}_{B}}{2 {F}_{y 1}} \vert}^{{η}_{1} - 1} ) + {Δ}_{u}$$

The force acting solely on the second sub-damper is:

$${ε}_{2}^{′} = \frac{{σ}_{2}^{′} - ( {σ}_{u} - {σ}_{B} )}{{E}_{2}} ( 1 + {α}_{2} {\vert \frac{{σ}_{2}^{′} - ( {σ}_{u} - {σ}_{B} )}{2 {F}_{y 2}} \vert}^{{η}_{2} - 1} ) + {Δ}_{u}$$

In the formula, E₂ is the initial stiffness of the second sub-damper; σᵤ, Δ₂ is the force and displacement at the inflection point; σ_{B} is the force at point B; F_{y2} is the yield force of the second sub-damper.

Therefore, the damping force of the metallic yielding asynchronized double-stage damper is: σ=σ₁′+σ₂′.

When ε varies from Δ_{E} to Δ_{F}, it indicates that the second sub-damper of the metallic yielding asynchronized double-stage damper has stopped working, and only the first sub-damper is unloaded. Unloading is complete when point F is reached.

At this point, the damping force of the metallic yielding asynchronized double-stage damper is σ=σ₁′.

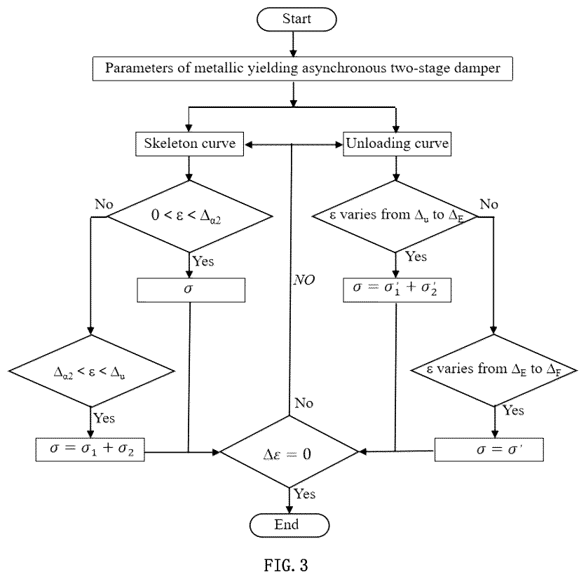

FIG. 3 shows a flowchart of algorithm of the metallic yielding asynchronized double-stage damper provided in an embodiment of the present disclosure. The algorithm includes the following steps:

First, obtain the parameters of the metallic yielding asynchronized double-stage damper.

Then, determine whether to use a skeleton curve or an unloading curve.

Use the skeleton curve and determine if the condition 0<ε<Δₐ₂ is met; if so, apply the formula σ, otherwise, further determine if the condition Δₐ₂<ε<Δᵤ is met; if so, apply the formula σ=σ₁+σ₂.

Use the unloading curve and determine if the condition that ε varies from Δᵤ to Δ_{E} is met; if yes, apply the formula σ=σ₁′+σ₂′, otherwise, further determine if the condition that ε varies from Δ_{E} to Δ_{F} is met; if yes, apply the formula σ=σ₁′.

The characteristics and performance of the damping force predicted by the theoretical calculation method for the metallic-yielding asynchronized double-stage damper in the present disclosure are further described in detail below in conjunction with the embodiments.

### Example 1

Currently, it is necessary to predict the loads of three types of metallic yielding asynchronized double-stage dampers under axial loading, including parallel double-stage yielding buckling restrained brace (PDYBRB), parallel double-stage crawler-track-shaped shear damper (PDCSD), and parallel double-stage shear panel damper (PDSPD). Table 1 lists the parameter values for the above three types of dampers. For each type of damper, there are two specimens with different performance parameters, they are consistent with the actual situation and the data are accurate and usable.

TABLE 1

| | $ F_{y1} | $E₁ | $Δₐ₂ | $ F_{y2} | $E₂ | | | | |
|---|---|---|---|---|---|---|---|---|---|
| | (10³N) | ((10⁶N/m) | (10⁻³m) | (10³N) | (10⁶N/m) | $α₁ | $η₁ | $α₂ | $η₂ |
| PDYBRB1 | 371 | 180.00 | 12.0 | 742 | 406.00 | 1 | 10 | 2 | 4 |
| PDYBRB2 | 479 | 230.00 | 15.8 | 1257 | 355.00 | 1 | 10 | 2 | 4 |
| PDCSD1 | 18 | 2.00 | 27.0 | 10.55 | 1.21 | 0.5 | 10 | 1 | 15 |
| PDCSD2 | 23 | 3.24 | 20.0 | 17.48 | 3.57 | 0.5 | 10 | 1 | 15 |
| PDSPD1 | 200 | 281.69 | 4.5 | 87.05 | 29.02 | 1 | 15 | 0.5 | 10 |
| PDSPD2 | 175 | 97.22 | 3.6 | 58.18 | 13.82 | 1 | 15 | 0.5 | 10 |

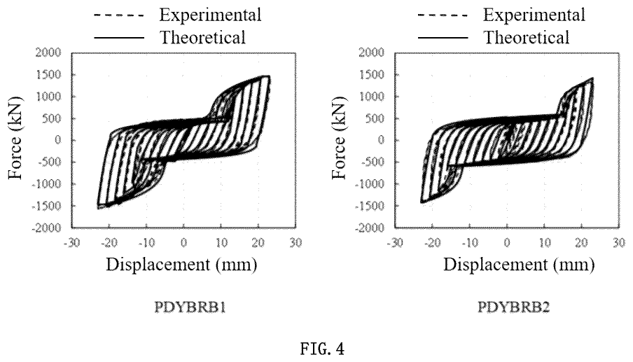

(1) Axial displacements of 2.3 mm, 4.6 mm, 6.9 mm, 9.2 mm, 11.5 mm, 13.8 mm, 16.1 mm, 18.4 mm, 20.7 mm, and 23 mm were axially applied to two parallel double-stage yielding buckling restrained braces (PDYBRBs) in successive stages. The displacements and PDYBRB parameters in Table 1 were substituted into the formula of the theoretical calculation method proposed above to predict the load changes of the parallel double-stage yielding buckling restrained braces (PDYBRBs) at different displacement deformation stages. FIG. 4 shows the load-deformation curves of PDYBRB1 and PDYBRB2 provided in the embodiment of the present disclosure, comparing experiment and theoretical calculation.

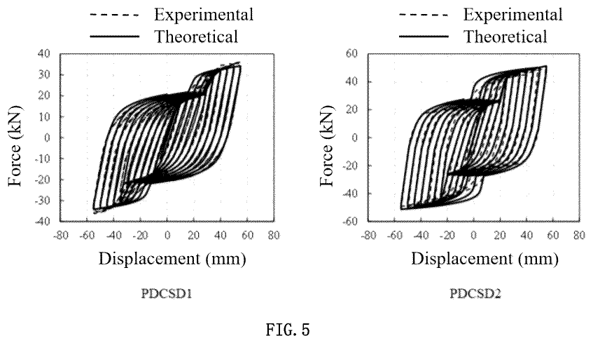

(2) Displacements of 5 mm, 10 mm, 15 mm, 20 mm, 25 mm, 30 mm, 35 mm, 40 mm, 45 mm, 50 mm, 55 mm, and 60 mm were applied to two parallel double-stage crawler-track-shaped shear dampers (PDCSDs) in successive stages. The displacements and PDCSD parameters in Table 1 were then substituted into the formula of the theoretical calculation method proposed above to predict the load changes of the parallel double-stage crawler-track-shaped shear dampers (PDCSDs) at different displacement deformation stages. FIG. 5 shows the load-deformation curves of PDCSD1 and PDCSD2 provided in the embodiment of the present disclosure, comparing experiment and theoretical calculation.

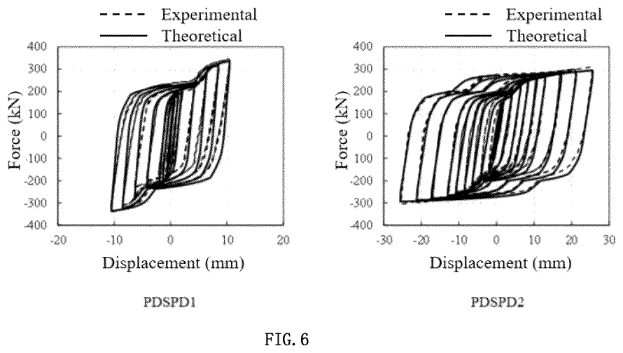

(3) Displacements of 0.7 mm, 1.4 mm, 2.1 mm, 4.2 mm, 6.3 mm, 8.4 mm, 10.5 mm, and 12.6 mm were applied to the first parallel double-stage shear panel damper (PDSPD1) in successive stages, and displacements of 1.0 mm, 2.1 mm, 4.2 mm, 6.3 mm, 8.4 mm, 10.5 mm, 12.6 mm, 16.8 mm, 21 mm, and 25.2 mm were applied to the second parallel double-stage shear panel damper (PDSPD2) in successive stages. The displacements and PDSPD parameters in Table 1 were substituted into the formula of the theoretical calculation method proposed above to predict the load changes of the parallel double-stage shear panel dampers (PDSPDs) at different displacement deformation stages. FIG. 6 shows the load-deformation curves of PDSPD1 and PDSPD2 provided in the embodiment of the present disclosure, comparing experiment and theoretical calculation.

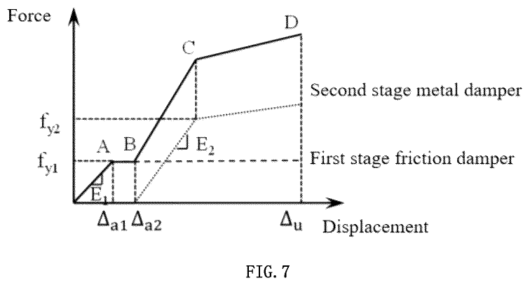

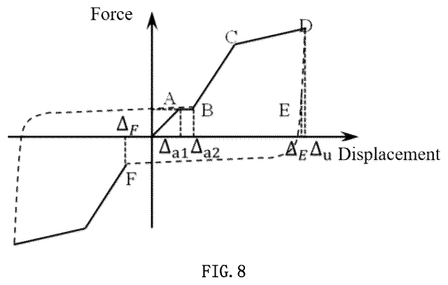

The theoretical calculation method for performance parameters of a friction-metal composite asynchronized double-stage damper provided in the embodiment of the present disclosure predicts stress in the four operating stages of existing friction-metal composite asynchronized double-stage dampers. Based on the device structure, a stress prediction formula is provided, solving the problem of studying the mechanical performance of this friction-metal composite asynchronized double-stage damper and effectively predicting the restoring force model of the friction-metal composite asynchronized double-stage damper. FIG. 7 shows the skeleton curve of the friction-metal composite asynchronized double-stage damper provided in the embodiment of the present disclosure, and FIG. 8 shows the hysteretic curve of the friction-metal composite asynchronized double-stage damper provided in the embodiment of the present disclosure.

### Skeleton Curve:

(1) When 0<ε<Δₐ₂, this indicates that only the first sub-damper of the friction-metal composite asynchronized double-stage damper is involved in the operation. When the load increases to the yield force of the first sub-damper, it reaches point A in the skeleton curve. At this time, only the first sub-damper provides stiffness and bearing capacity, the asynchronous force transmission system is not activated, and the deformation of the second sub-damper is 0. The damping force of the parallel-connected double-stage energy dissipation and vibration reduction device at this time is:

$$σ = {E}_{1} \cdot ε$$

wherein, ε, σ represent the displacement and force of the friction-metal composite asynchronized double-stage damper; E₁ represents the initial stiffness of the first sub-damper.

(2) When Δₐ₁<ε<Δₐ₂, the first-stage friction damper yields, and σ=F_{y1}, F_{y1} is the yield force of the first sub-damper.

(3) When Δₐ₂<ε<Δᵤ, this indicates that the second sub-damper of the friction-metal composite asynchronized double-stage damper is activated, the two sub-dampers work in parallel, the first sub-damper continues to consume energy, while the second sub-damper provides stiffness and bearing capacity. There is a constant deformation difference between the first and second sub-dampers. When the second sub-damper yields, the stress on the support reaches point C in the skeleton curve, until the support reaches the maximum axial deformation Δᵤ.

At this point, the first friction sub-damper had already yielded, σ₁=F_{y1}.

The force acting solely on the second metal sub-damper is:

$${ε}_{2} = \frac{{σ}_{2}}{{E}_{2}} ( 1 + {α}_{2} {\vert \frac{{σ}_{2}}{{F}_{y 2}} \vert}^{{η}_{2} - 1} ) + {Δ}_{a 2}$$

where E₂ is the initial stiffness of the second sub-damper; F_{y2} is the yield force of the second sub-damper; Δₐ₂ is the displacement at point B, i.e., the second-stage starting displacement; α₂, η₂ are the shape parameters of the second sub-damper.

Then the damping force of the friction-metal composite asynchronized double-stage damper at this time is: σ=σ₁+σ₂.

### Unloading Curve:

Under repeated loading, when the steel yields in one direction and is unloaded to zero and then loaded in the opposite direction, that is, when ε varies from Δᵤ to Δ_{E}, the first and second sub-dampers work together and unload together, the second sub-damper stops working when the inflection point E is reached.

At this time, the force solely on the first friction sub-damper is σ₁′=F_{y1}+E₁·(ε−Δᵤ), when σ₁′≤−F_{y1}, σ₁′=−F_{y1}.

The force acting solely on the second metal sub-damper is:

$${ε}_{2}^{′} = \frac{{σ}_{2}^{′} - ( {σ}_{u} - {σ}_{B} )}{{E}_{2}} ( 1 + {α}_{2} {\vert \frac{{σ}_{2}^{′} - ( {σ}_{u} - {σ}_{B} )}{2 {F}_{y 2}} \vert}^{{η}_{2} - 1} ) + {Δ}_{u}$$

In the formula, E₂ is the initial stiffness of the second sub-damper; σᵤ, Δᵤ is the force and displacement at the inflection point; σ_{B} is the force at point B; F_{y2} is the yield force of the second sub-damper; α₂, η₂ are the shape parameters of the second sub-damper. Therefore, the damping force ‘of the friction-metal composite asynchronized double-stage damper is: σ=σ₁′+σ₂′.

When ε varies from Δ_{E} to Δ_{F}, it indicates that the second sub-damper of the friction-metal composite asynchronized double-stage damper has stopped working, and only the first sub-damper is unloaded. Unloading is complete when point F is reached.

At this time, the damping force of the friction-metal composite asynchronized double-stage damper is σ=σ₁′.

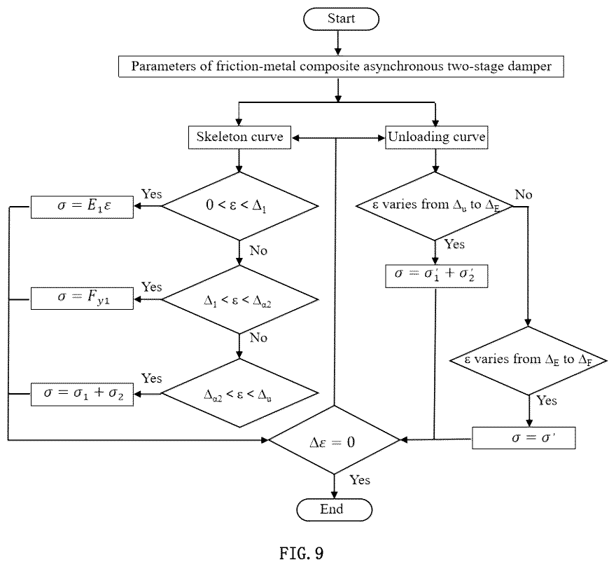

FIG. 9 shows a flowchart of algorithm of the friction-metal composite asynchronized double-stage damper provided in an embodiment of the present disclosure. The algorithm includes the following steps:

First, obtain the parameters of the friction-metal composite asynchronized double-stage damper.

Then, determine whether to use a skeleton curve or an unloading curve.

Use a skeleton curve and determine if the condition 0<ε<Δₐ₂ is met; if so, apply the formula σ=E₁·ε. Determine if the condition Δ₁<ε<Δₐ₂ is met; if so, apply the formula σ=F_{y1}. Determine if the condition Δₐ₂<ε<Δᵤ is met; if so, apply the formula σ=σ₁+σ₂.

Use the unloading curve and determine if the condition that ε varies from Δᵤ to Δ_{E} is met; if yes, apply the formula σ=σ₁′+σ₂′, otherwise, further determine if the condition that ε varies from Δ_{E} to Δ_{F} is met; if yes, apply the formula σ=σ₁′.

The characteristics and performance of the damping force predicted by the theoretical calculation method for the friction-metal composite asynchronized double-stage damper in the present disclosure are further described in detail below in conjunction with the embodiments.

### Example 2

Currently, it is necessary to predict the load variations of three friction-metal composite asynchronized double-stage damper specimens at different displacement stages. Table 2 lists the parameters of the three friction-metal composite asynchronized double-stage dampers, they are consistent with the actual situation and the data are accurate and usable.

TABLE 2

| | | $E₁ | | | $E₂ | | |
|---|---|---|---|---|---|---|---|
| | $ F_{y1} | (10⁶N/ | $Δₐ₂ | $ F_{y2} | (10⁶N/ | | |
| | (10³N) | m) | (10^{-3m}) | (10³N) | m) | $α₂ | $η₂ |
| APDFMD1 | 210 | 140 | 45 | 70 | 23.33 | 0.5 | 15 |
| APDFMD2 | 200 | 172 | 3.5 | 75 | 16.66 | 0.5 | 15 |
| APDFMD3 | 210 | 130 | 9.5 | 70 | 23.33 | 0.5 | 15 |

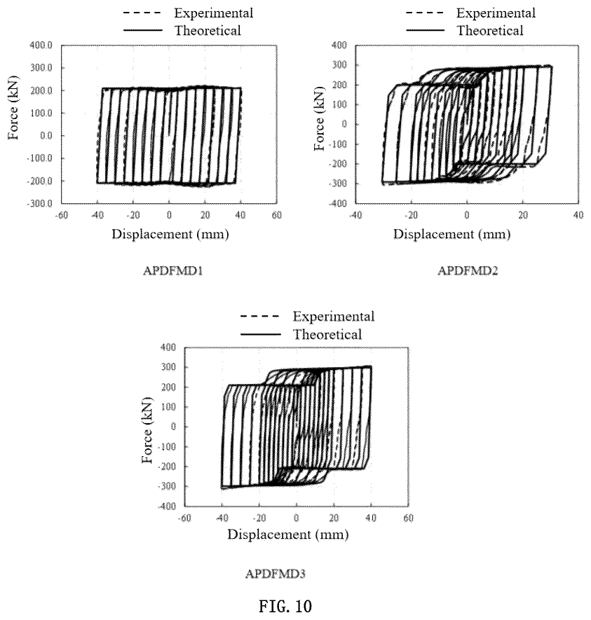

Displacements of 5 mm, 10 mm, 15 mm, 20 mm, 25 mm, 30 mm, 35 mm, and 40 mm were applied to the first asynchronized-type parallel double-stage friction-metal damper (APDFMD1). Displacements of 2.5 mm, 5 mm, 7.5 mm, 10 mm, 12.5 mm, 15 mm, 17.5 mm, 20 mm, 25 mm, and 30 mm were applied to the second asynchronized-type parallel double-stage friction-metal damper (APDFMD2). Displacements of 2.5 mm, 5 mm, 7.5 mm, 10 mm, 12.5 mm, 15 mm, 17.5 mm, 20 mm, 25 mm, 30 mm, 35 mm, and 40 mm were applied to the third asynchronized-type parallel double-stage friction-metal damper (APDFMD3). The displacements and APDFMD parameters in Table 1 were substituted into the formulas of the above theoretical calculation method to predict the load changes of the asynchronized-type parallel double-stage friction-metal dampers (APDFMD) at different displacement deformation stages. FIG. 10 shows the load-deformation curves of APDFMD1, APDFMD2 and APDFMD3 provided in the embodiment of the present disclosure, comparing experiment and theoretical calculation.

Current calculation software cannot perform specific and accurate analysis and calculation for asynchronous starting double-stage energy dissipation and vibration reduction devices (metallic yielding type asynchronized double-stage dampers and friction-metal composite type asynchronized double-stage dampers), and the stress of the damper and relationship with its structure cannot be predicted. Using the method provided in this embodiment, the damping force and relationship with its structure of the two types of asynchronous starting double-stage energy dissipation and vibration reduction devices can be calculated more accurately.

The present disclosure proposes two calculation methods for asynchronous starting double-stage energy dissipation and vibration reduction device. These methods can predict the damping force based on the damper structure, effectively simulate the working process of the asynchronous starting double-stage energy dissipation and vibration reduction device, and analyze the damping force-displacement hysteretic curves under different positional variations. This optimizes the damping force calculation method for asynchronous starting double-stage energy dissipation and vibration reduction devices. In summary, this solution effectively solves the technical problems of asynchronous starting double-stage energy dissipation and vibration reduction devices, namely:
(1) A restoring force model for asynchronous starting double-stage energy dissipation and vibration reduction device is proposed, which can effectively carry out seismic response analysis of structures with parallel double-stage energy dissipation and vibration reduction device added;
(2) Two theoretical calculation methods for the performance parameters of asynchronous starting double-stage energy dissipation and vibration reduction device are proposed, which are beneficial to the in-depth design of production-oriented asynchronous starting double-stage energy dissipation and vibration reduction devices.

The two hysteretic behavior prediction methods for asynchronous starting double-stage energy dissipation and vibration reduction devices provided in the present disclosure can accurately and specifically analyze and calculate the hysteretic behavior of these devices when the structure encounters different types and levels of disasters. This method can relatively accurately predict the hysteretic behavior of the asynchronous starting double-stage energy dissipation and vibration reduction devices under different axial deformations.

Two restoring force models for asynchronous starting double-stage energy dissipation and vibration reduction device are proposed, which can effectively carry out seismic response analysis of structures with parallel double-stage energy dissipation and vibration reduction device.

Two theoretical calculation methods for the performance parameters of asynchronous starting double-stage energy dissipation and vibration reduction device are proposed, which are beneficial for the in-depth design of production-oriented asynchronous starting double-stage energy dissipation and vibration reduction devices.

The present disclosure also provides a universal simulation system for the hysteretic behavior of an asynchronized double-stage energy dissipation and vibration reduction device, applied to a metallic yielding asynchronized double-stage damper, wherein the metallic yielding asynchronized double-stage damper includes a first sub-damper and a second sub-damper, and the system is used to execute the above method.

The present disclosure also provides a universal simulation system for the hysteretic behavior of an asynchronized double-stage energy dissipation and vibration reduction device, which is applied to a friction-metal composite asynchronized double-stage damper, wherein the friction-metal composite asynchronized double-stage damper includes a first friction sub-damper and a second metal sub-damper, and the system is used to execute the above method.

The system provided in the embodiments has the same implementation principle and technical effects as the previously described embodiments. For the sake of brevity, any parts not mentioned in the embodiments of device can be referred to the corresponding content in the aforementioned embodiments of method.

The present disclosure provides an electronic device, which includes a processor and a memory. The memory stores a computer program that can run on the processor. When the processor executes the computer program, it implements the steps of the method provided in the above embodiments.

The present disclosure provides a computer-readable medium storing computer-executable instructions. When these computer-executable instructions are invoked and executed by a processor, they cause the processor to implement the methods described in the above embodiments.

Those skilled in the art will understand that all or part of the processes in the above embodiments can be implemented by computer-controlled devices. The program can be stored in a computer-readable storage medium. When the program is executed, it can include the processes of the above method embodiments. The storage medium can be a memory, a disk, an optical disk, etc.

In this document, relational terms such as “first” and “second” are used merely to distinguish one entity or operation from another, without necessarily requiring or implying any such actual relationship or order between these entities or operations.

Furthermore, the terms “comprising,” “including,” or any other variations thereof are intended to cover non-exclusive inclusion, such that a process, method, article, or apparatus that comprises a list of elements includes not only those elements but also other elements not expressly listed, or elements inherent to such a process, method, article, or apparatus. Without further limitation, an element defined by the phrase “comprising one . . . ” does not exclude the presence of other identical elements in the process, method, article, or apparatus that includes said element.

Various embodiments in this specification are described in a progressive manner, with each embodiment focusing on the differences from other embodiments. The same or similar parts between the various embodiments can be referred to each other.

The above description of the disclosed embodiments enables those skilled in the art to make or use the present disclosure. Various modifications to these embodiments will be readily apparent to those skilled in the art, and the universal principles defined herein may be implemented in other embodiments without departing from the spirit or scope of the present disclosure. Therefore, the present disclosure is not to be limited to the embodiments shown herein, but is to be accorded the widest scope consistent with the principles and novel features disclosed herein.

What is claimed is:

1. A universal simulation method for hysteretic behavior of an asynchronized double-stage energy dissipation and vibration reduction device, applied to a metallic yielding asynchronized double-stage damper, wherein the metallic yielding asynchronized double-stage damper comprises a first sub-damper and a second sub-damper, and the method comprises:
obtaining parameters of the metallic yielding asynchronized double-stage damper,
wherein, in a case where 0<ε<Δₐ₂, a damping force of the metallic yielding asynchronized double-stage damper satisfies the following formula:
$$ε = \frac{σ}{{E}_{1}} ( 1 + {α}_{1} {\vert \frac{σ}{{F}_{y 1}} \vert}^{{η}_{1} - 1} )$$
where, ε, σ represent displacement and force of the metallic yielding asynchronized double-stage damper; E₁ represents initial stiffness of the first sub-damper; F_{y1} represents yield force of the first sub-damper; α₁, η₁ represent shape parameters of the first sub-damper; Δₐ₂ represents second-stage starting displacement.
in a case where Δₐ₂<ε<Δᵤ, a force acting solely on the first sub-damper satisfies the following formula:
$${ε}_{1} = \frac{{σ}_{1}}{{E}_{1}} ( 1 + {α}_{1} {\vert \frac{{σ}_{1}}{{F}_{y 1}} \vert}^{{η}_{1} - 1} )$$
and a force solely acting on the second sub-damper satisfies the following formula:
$${ε}_{2} = \frac{{σ}_{2}}{{E}_{2}} ( 1 + {α}_{2} {\vert \frac{{σ}_{2}}{{F}_{y 2}} \vert}^{{η}_{2} - 1} ) + {Δ}_{a 2}$$
the damping force of the metallic yielding asynchronized double-stage damper is:
$$σ = {σ}_{1} + {σ}_{2} ;$$
where, E₂ represents initial stiffness of the second sub-damper; F_{y2} represents yield force of the second sub-damper; Δᵤ represents maximum axial deformation; α₂, η₂ represents shape parameters of the second sub-damper; σ₁ represents a force of the first sub-damper; σ₂ represents a force of the second sub-damper.

2. The method according to claim 1, wherein, when ε varies from Δᵤ to Δ_{E}, the damping force of the metallic yielding asynchronized double-stage damper satisfies the following formula:
the force acting solely on the first sub-damper is:
$${ε}_{1}^{′} = \frac{{σ}_{1}^{′} - {σ}_{B}}{{E}_{1}} ( 1 + {α}_{1} {\vert \frac{{σ}_{1}^{′} - {σ}_{B}}{2 {F}_{y 1}} \vert}^{{η}_{1} - 1} ) + {Δ}_{u}$$
the force acting solely on the second sub-damper is:
$${ε}_{2}^{′} = \frac{{σ}_{2}^{′} - ( {σ}_{u} - {σ}_{B} )}{{E}_{2}} ( 1 + {α}_{2} {\vert \frac{{σ}_{2}^{′} - ( {σ}_{u} - {σ}_{B} )}{2 {F}_{y 2}} \vert}^{{η}_{2} - 1} ) + {Δ}_{u}$$
the damping force of the metallic yielding asynchronized double-stage damper is:
$$σ = {σ}_{1}^{′} + {σ}_{2}^{′} ;$$
where, E₂ represents initial stiffness of the second sub-damper; σᵤ, Δᵤ represent force and displacement at an inflection point; σ_{B} represents a force at point B; F_{y2} represents yield force of the second sub-damper; Δ_{E} represents the inflection point, at which the second sub-damper stops working; σ₁′ represents the force of the first sub-damper; σ₂′ represents the force of the second sub-damper.
when ε varies from Δ_{E} to Δ_{F}, the damping force of the metallic yielding asynchronized double-stage damper is σ=σ₁′, where Δ_{F} is an unloading completion point.

3. The method according to claim 2, wherein the method further comprises:
plotting a skeleton curve and an unloading curve based on the calculation formula of the damping force of the metallic yielding asynchronized double-stage damper.

4. The method according to claim 2, wherein the method further comprises:
designing performance parameters of the metallic yielding asynchronized double-stage damper based on the calculation formula of the damping force and a vibration reduction requirement of the metallic yielding asynchronized double-stage damper.

5. A universal simulation method for hysteretic behavior of an asynchronized double-stage energy dissipation and vibration reduction device, applied to a friction-metal composite asynchronized double-stage damper, wherein the friction-metal composite asynchronized double-stage damper comprises a first friction sub-damper and a second metal sub-damper, and the method comprises:
obtaining parameters of the friction-metal composite asynchronized double-stage damper;
wherein, in a case where 0<ε<Δₐ₁, a damping force of the friction-metal composite asynchronized double-stage damper satisfies the following formula:
$$σ = {E}_{1} \cdot ε$$
where, ε, σ represent displacement and force of the friction-metal composite asynchronized double-stage damper; E₁ represents initial stiffness of the first friction sub-damper; Δₐ₁ represents a displacement when a load increases to a yield force of the first friction sub-damper.
in a case where Δₐ₁<ε<Δₐ₂, the damping force of the friction-metal composite asynchronized double-stage damper satisfies the following formula:
$$σ = {F}_{y 1}$$
where F_{y1} represents the yield force of the first friction sub-damper; Δₐ₂ represents second-stage starting displacement.
in a case where Δₐ₂<ε<Δᵤ,
a force acting solely on the first friction sub-damper is: σ₁=F_{y1};
a force acting solely on the second metal sub-damper is:
$${ε}_{2} = \frac{{σ}_{2}}{{E}_{2}} ( 1 + {α}_{2} {\vert \frac{{σ}_{2}}{{F}_{y 2}} \vert}^{{η}_{2} - 1} ) + {Δ}_{a 2}$$
where, E₂ represents initial stiffness of the second metal sub-damper; F_{y2} represents yield force of the second metal sub-damper; Δₐ₂ represents second-stage starting displacement; Au represents maximum axial deformation; α₂, η₂ represents shape parameters of the second metal sub-damper;
the damping force of the friction-metal composite asynchronized double-stage damper is: σ=σ₁+σ₂.

6. The method according to claim 5, wherein, when ε varies from Δᵤ to Δ_{E}, the damping force of the friction-metal composite asynchronized double-stage damper satisfies the following formula:
the force acting solely on the first friction sub-damper is:
$${σ}_{1}^{′} = {F}_{y 1} + {E}_{1} \cdot ( ε - {Δ}_{u} ) At that time {σ}_{1}^{′} \leq - {F}_{y 1} , {σ}_{1}^{′} = - {F}_{y 1} ,$$
the force acting solely on the second metal sub-damper is:
$${ε}_{2}^{′} = \frac{{σ}_{2}^{′} - ( {σ}_{u} - {σ}_{B} )}{{E}_{2}} ( 1 + {α}_{2} {\vert \frac{{σ}_{2}^{′} - ( {σ}_{u} - {σ}_{B} )}{2 {F}_{y 2}} \vert}^{{η}_{2} - 1} ) + {Δ}_{u}$$
where, E₂ represents initial stiffness of the second metal sub-damper; σᵤ, Δᵤ represent force and displacement at an inflection point; σ_{B} represents a force at point B; F_{y2} represents yield force of the second metal sub-damper; Δ_{E} represents the inflection point, at which the second metal sub-damper stops working; σ₁′ represents the force of the first friction sub-damper; σ₂′ represents the force of the second metal sub-damper.
the damping force of the friction-metal composite asynchronized double-stage damper is: σ=σ₁′+σ₂′;
when ε varies from Δ_{E} to Δ_{F}, the damping force of the friction-metal composite asynchronized double-stage damper is σ=σ₁′, where Δ_{F} is an unloading completion point.

7. The method according to claim 6, wherein the method further comprises:
plotting a skeleton curve and an unloading curve based on the calculation formula of the damping force of the friction-metal composite asynchronized double-stage damper.

8. The method according to claim 6, wherein the method further comprises:
designing performance parameters of the friction-metal composite asynchronized double-stage damper based on the calculation formula of the damping force and a vibration reduction requirement of the friction-metal composite asynchronized double-stage damper.

9. A universal simulation system for hysteretic behavior of an asynchronized double-stage energy dissipation and vibration reduction device, applied to a metallic yielding asynchronized double-stage damper, wherein the metallic yielding asynchronized double-stage damper comprises a first sub-damper and a second sub-damper, and the system is used to perform the method as described in claim 1.

10. A universal simulation system for hysteretic behavior of an asynchronized double-stage energy dissipation and vibration reduction device, applied to a friction-metal composite asynchronized double-stage damper, wherein the friction-metal composite asynchronized double-stage damper comprises a first friction sub-damper and a second metal sub-damper, and the system is used to perform the method as described in claim 5.
